(19) United States
(12) Patent Application Publication
(10) Pub. No.: US 2011/0307952 A1
(43) Pub. Date: Dec. 15, 2011

(54) ELECTRONIC DEVICE WITH PASSWORD GENERATING FUNCTION AND METHOD THEREOF

(75) Inventor: ZHUO XIE, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City, (CN)

(21) Appl. No.: 12/953,473

(22) Filed: Nov. 24, 2010

(30) Foreign Application Priority Data
Jun. 11, 2010 (CN) 201010197876.1

(51) Int. Cl. G06F 21/00

(52) U.S. Cl. 726/18

(57) ABSTRACT

An electronic device with a password generating function is provided. The electronic device stores a number of password keys. The electronic device generates a password editing interface for user to edit a graphic password. The password editing interface includes a password key area and a password editing area. The password key area displays the password keys and the password editing area is provided for editing the password keys. The password key is selected from the password key area to the password editing area to edit the graphic password.

### BACKGROUND

1. Technical Field

The present disclosure relates to an electronic device with a password generating function and a method thereof.

2. Description of Related Art

For security requirements, passwords are set for encrypting/decrypting files or set authorization for users to login to an electronic device or a server. Generally, the password is a combination of characters and numbers and it is sometimes difficult for the user to remember.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device with a password generating function in accordance with an exemplary embodiment.

FIG. 2 is a schematic diagram of a password editing interface displayed by the electronic device of FIG. 1.

FIG. 3 is a schematic diagram of geometric figures with feature points displayed in the password editing interface of FIG. 2.

FIG. 4 is a flowchart of a method for generating a password applied on the electronic device of FIG. 1, in accordance with an exemplary embodiment.

### DETAILED DESCRIPTION

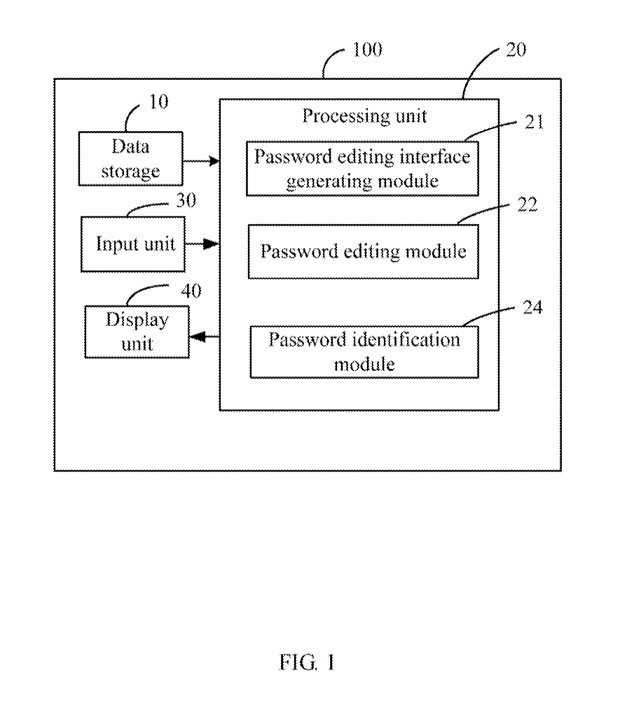

FIG. 1 is a block diagram of an electronic device 100 with a password generating function (hereinafter “the electronic device”). The electronic device 100 includes a data storage 10, a processing unit 20, an input unit 30, and a display unit 40.

The data storage 10 stores a number of password keys. The password keys are used to generate passwords. The password keys include, but not limited to, colors and geometric figures. The detail description of how to generate the passwords using the password keys will be described below.

The processing unit 20 includes a password editing interface generating module 21, a password editing module 22, and a password identification module 24.

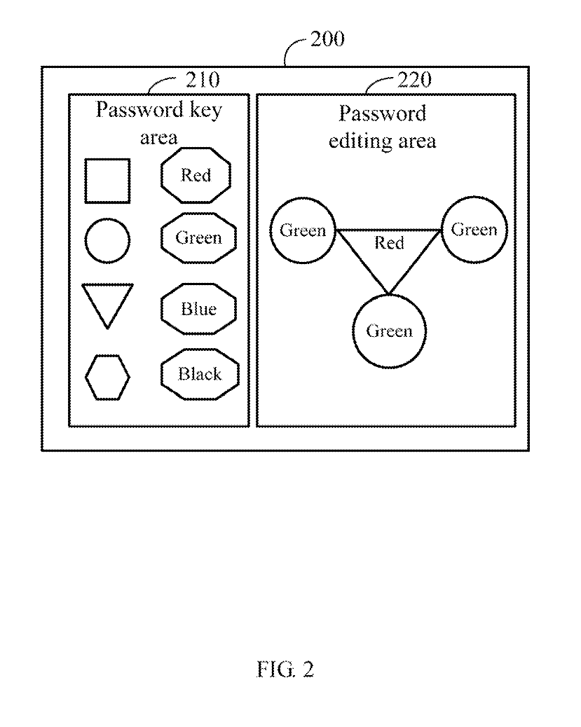

The password editing interface generating module 21 is configured for generating a password editing interface 200 on the display 40 according to operations on the input unit 30. As shown in FIG. 2, the password editing interface 200 includes a password key area 210 and a password editing area 220. The password key area 210 displays the password keys (e.g., geometric figures and colors) obtained from the data storage 10. In this exemplary embodiment, the geometric figures include, but are not limited to, rectangle, circle, triangle, and hexagon as shown at the left of the password key area 210. The colors include, but not limited to, red, green, blue, and black, as shown at the right of the password key area 210.

When generating the passwords, the password editing module 22 transmits the selected password keys from the password key area 210 to the password editing area 220 in response to a selection operation.

The password identification module 24 determines whether the generated password matches a pre-stored password in response to a login operation or a decryption operation on the input unit 30. If the generated password matches the pre-stored password, a predetermined function of the operation on the input unit 30 is activated, for example, logging in to an electronic device or a server, or decrypting a file. If the generated password does not match the pre-stored password, a warning that the password is not correct is generated. In this embodiment, the graphic password is taken for example. The detail description about that how to determine the match of the graphic password and the pre-stored password will be described below.

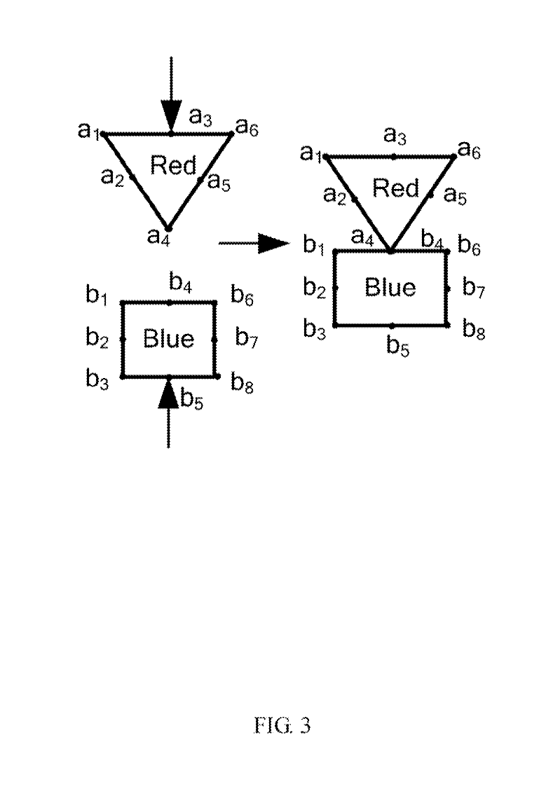

In this embodiment, each geometric figure includes a number of feature points. As shown in FIG. 3, the triangle includes six feature points, namely a1-a6. The six feature points are positioned in three vertexes and midpoints of three sides of the triangle. The rectangle includes eight feature points, namely b1-b8. The eight feature points are positioned in four vertexes and midpoints of four sides of the rectangle. After the graphic password is created, one of the feature points of the graphic password is selected as an origin of coordinates according to a predetermined rule, and coordinates of other feature points of the graphic password are determined accordingly. In this embodiment, the predetermined rule is that the first feature point, which is first scanned when an image of the graphic password is scanned from the left to the right or from the top to the bottom, is selected as the origin of coordinates. For example, in this embodiment, if the predetermined rule is that the first feature point, which is first scanned when an image of the graphic password is scanned from the left to the right, is selected as the origin of coordinates, the feature point a1 is selected as the origin of coordinates. The coordinates of the feature points are stored to the data storage 11.

When determining whether the generated graphic password matches the pre-stored password. The password identification module 23 obtains the coordinates of the feature points of the generated graphic password from the data storage 11, and determines whether the feature points of the graphic password are the same as the feature points of the pre-stored password according to coordinates of the feature points of the graphic password and the pre-stored password. If the feature points are the same as the feature points of the pre-stored password, the password identification module 23 determines that the graphic password matches the pre-stored password. If there is one or more feature points are not the same as the feature points of the pre-stored password, the password identification module 23 determines that the graphic password does not match the pre-stored password.

In this embodiment, when selecting the password keys, the colors in the password key area 210 can be selected to fill in the selected geometric figure(s) in the password editing area 220. The selected geometric figure(s) and the colors are combined together to form a graphic password, as shown in the password editing area 220. The formed graphic password is stored to the data storage 11. After determined that the feature points matches the feature points of the pre-stored password, the password identification module 23 further obtains pixel of a predetermined area in each geometric figures, and determined whether the obtained pixel matches the pixel of the corresponding geometric figure of pre-stored graphic password, if the pixel of one geometric figure does not match the pixel of corresponding geometric figure of the pre-stored graphic password, the password identification module 23 determines that the graphic password does not match the pre-stored password.

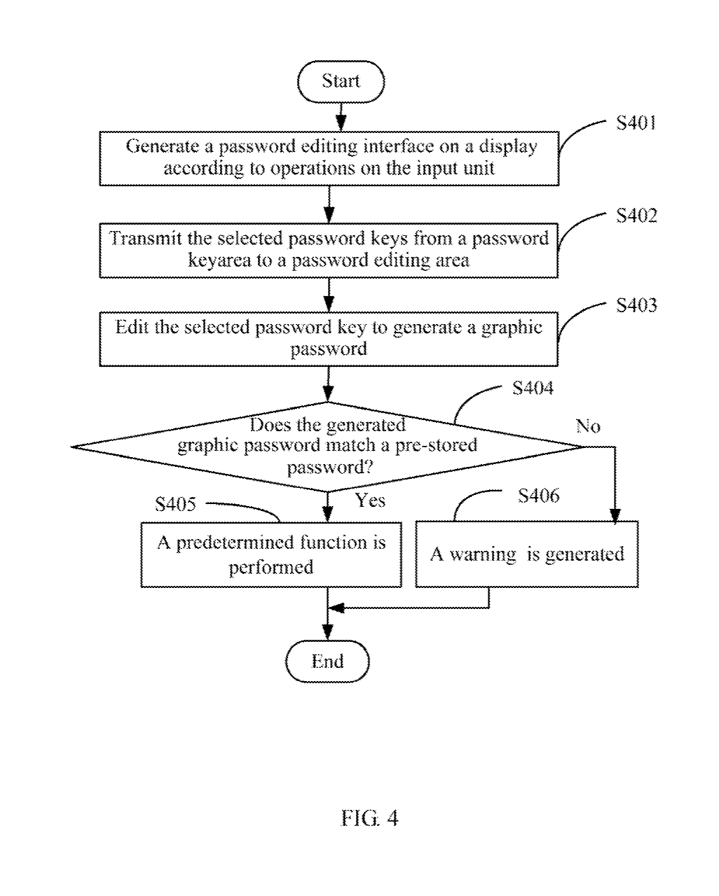

FIG. 4 is a flowchart of a method for generating a password applied on the electronic device of FIG. 1. In step S401, the password editing interface generating module 21 generates the password editing interface 200 on the display 40 according to the operations on the input unit 30. The password editing interface 200 includes the password key area 210 and the password editing area 220. Password keys are selected from the password key area 210.

In step S402, the password editing module 22 transmits the selected password keys from the password key area 210 of the password editing interface 200 to the password editing area 220 of the password editing interface 200 in response to the selection operation.

In step S403, the password editing module 22 edits the selected password key to generate a graphic password and stores the password to the data storage 11.

In step S404, the password identification module 24 determines whether the generated password matches the pre-stored password in response to the login operation or the decryption operation.

In step S405, if the generated password matches the pre-stored password, a predetermined function is performed, such as loading to an electronic device or server, or decrypting a file.

In step S406, if the generated password does not match the pre-stored password, the warning that the password is not correct is generated.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device with a password generating function, the electronic device comprising:
a data storage for storing a plurality of password keys;
a password editing interface generating module for generating a password editing interface, wherein the password editing interface comprises a password key area and a password editing area, the password key area displays the password keys obtained from the data storage, the password editing area for editing the password keys;
a password editing module for transmitting at least one selected password key from the password key area to the password editing area and editing the at least one selected password key to generate a graphic password and stores the password to the data storage.

2. The electronic device as described in claim 1, further comprising a password identification module for determining whether the generated graphic password matches the pre-stored password in response to a predetermined operation, wherein, if the generated graphic password matches the pre-stored password, an predetermined function is performed, if the generated graphic password does not match the pre-stored password, a warning about the graphic password is not correct is generated.

3. The electronic device as described in claim 1, wherein the predetermined operation is a login operation or a decryption operation.

4. The electronic device as described in claim 1, wherein the password keys comprise geometric.

5. The electronic device as described in claim 4, wherein each geometric figure defines a plurality of feature points, after the graphic password is edited, one of the feature points of the graphic password is selected as an origin of coordinates according to a predetermined rule, and coordinates of other feature points of the graphic password are determined accordingly, when determining whether the generated graphic password matches the pre-stored password, the password identification module obtains the coordinates of the feature points of the generated graphic password, and determines whether the feature points of the graphic password are the same as the feature points of the pre-stored password according to coordinates of the feature points of the graphic password and the pre-stored password, if the feature points are the same as the feature points of the pre-stored password, the password identification module determines that the graphic password matches the pre-stored password, if there is one or more feature points that are not the same as the feature points of the pre-stored password, the password identification module determines that the graphic password does not match the pre-stored password.

6. The electronic device as described in claim 5, wherein the predetermined rule is that the first feature point, which is first scanned when an image of the graphic password is scanned from the left to the right or from the top to the bottom, is selected as the origin of coordinates.

7. The electronic device as described in claim 5, wherein the predetermined rule is that the first feature point, which is first scanned when an image of the graphic password is scanned from the left to the right or from the top to the bottom, is selected as the origin of coordinates.

8. The electronic device as described in claim 5, wherein the password keys further comprises colors, the colors are to be selected to fill the selected geometric figures.

9. The electronic device as described in claim 8, wherein the geometric figures and the colors are to be selected to generate a graphic password.

10. The electronic device as described in claim 9, wherein after determined that the feature points matches the feature points of the pre-stored password, the password identification module further obtains pixel of a predetermined area in each geometric figures, and determined whether the obtained pixel matches the pixel of the corresponding geometric figure of pre-stored graphic password, if the pixel of one geometric figure does not match the pixel of corresponding geometric figure of the pre-stored graphic password, the password identification module determines that the graphic password does not match the pre-stored password.

11. A method for generating a password applied on an electronic device, the electronic device storing a plurality of password keys, the method comprising:
generating a password editing interface, wherein the password editing interface comprises a password key area and a password editing area, the password key area displays the password keys obtained from the electronic device, the password editing area for editing the password keys;
transmitting the selected at least one password key from the password key area to the password editing area and editing the at least one selected password key to generate a graphic password and stores the graphic password to the electronic device.

12. The method as described in claim 11, further comprising:
determining whether the generated graphic password matches the pre-stored password in response to a predetermined operation;
performing an predetermined function if the generated password matches the pre-stored password;
generating a warning about the graphic password is not correct if the generated password does not match the pre-stored password.

13. The method as described in claim 11, wherein the predetermined operation is a login operation or a decryption operation.

14. The method as described in claim 10, wherein the password key is geometric figures.

15. The method as described in claim 14, wherein the password key further comprises colors, the color is selected to fill the selected geometric figures.

16. The method as described in claim 15, wherein the geometric figures and the colors is edited to a graphic diagram.

17. The method as described in claim 16, wherein each geometric figure defines feature points, after the graphic password is edited, one of the feature points of the graphic password is selected as an origin of coordinates according to a predetermined rule, and coordinates of other feature points of the graphic password are determined accordingly, when determining whether the generated graphic password matches the pre-stored password, further comprising:
obtaining the coordinates of the feature points of the generated graphic password, and determines whether the feature points of the graphic password are the same as the feature points of the pre-stored password according to coordinates of the feature points of the graphic password and the pre-stored password.

18. The method as described in claim 15, wherein the predetermined rule is that the first feature point, which is first scanned when an image of the graphic password is scanned from the left to the right or from the top to the bottom, is selected as the origin of coordinates.
